(19) United States
(12) Patent Application Publication
(10) Pub. No.: US 2006/0269071 A1
(43) Pub. Date: Nov. 30, 2006

(54) Virtual sound localization processing apparatus, virtual sound localization processing method, and recording medium

(76) Inventor: Kenji Nakano, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/393,695

(22) Filed: Mar. 31, 2006

(30) Foreign Application Priority Data
Apr. 22, 2005 (JP) 2005-125064

(51) Int. Cl. H04R 5/00

(52) U.S. Cl. 381/17

(57) ABSTRACT

A virtual sound localization processing apparatus which forms first/second main signals for localizing a sound image to a predetermined position around the listener from acoustic signals of a sound source includes: first/second output terminals for outputting acoustic signals to be supplied to first/second speakers arranged to left and right; third/fourth output terminals for outputting acoustic signals to be supplied to third/fourth speakers arranged near those speakers; and two auxiliary signal forming units for forming auxiliary signals for localizing the sound image to the predetermined position around the listener from the acoustic signals of the sound source. The acoustic signal including the first main signal and the acoustic signal including the second main signal are supplied to the first/second output terminals. The acoustic signals including the auxiliary signals formed by the auxiliary signal forming units are supplied to the third/fourth output terminals.

### CROSS REFERENCES TO RELATED APPLICATIONS

The present invention contains subject matter related to Japanese Patent Application JP 2005-125064 filed in the Japanese Patent Office on Apr. 22, 2005, the entire contents of which being incorporated herein by reference.

### BACKGROUND OF THE INVENTION

1. Field of the Invention

The invention relates to a virtual sound localization processing apparatus, a virtual sound localization processing method, and a recording medium in which, for example, even if a listening position is changed, the listener can obtain a stereophonic acoustic effect.

2. Description of the Related Arts

In a stereophonic acoustic reproduction for stereophonically reproducing an audio sound, there is a case where a plurality of channels are used. Particularly, there is a case where three or more channels are called a multichannel. As a typical example of the multichannel, a 5.1-channel system is widely known. The 5.1 channels denote a channel construction formed by a front center channel (C), front left/right channels (L/R), rear left/right channels (SL/SR), and an auxiliary channel (SW) for a low frequency effect (LFE) for the listener. In the 5.1 channels, by arranging a speaker corresponding to each channel to a predetermined position around the listener, for example, a surround reproduction sound having such an ambience that the listener exists in a concert hall or a movie theater can-be provided to the listener.

As sources of multichannel audio (or multichannel audio/visual) represented by 5.1-channels, for example, package media such as DVD (Digital Versatile Disc) audio, DVD video, super audio CD, and the like exist. Also in an audio signal format of a BS (Broadcasting Satellite)/CS (Communication Satellite) digital broadcasting and a terrestrial wave digital broadcasting both of which are expected to be widely spread in future, the 5.1 channels have been specified as the maximum number of audio channels;

In the case of listening the audio sounds by the 5.1-channel system as mentioned above, since at least six speakers corresponding to those channels need to be arranged around the listener, a space where those speakers can be arranged is necessary. Therefore, if the space where the six speakers are arranged cannot be assured, it is difficult for the listener to listen to the audio sounds by the 5.1-channel system.

Further, although a 6.1-channel system in which a speaker is also arranged at the center of the rear side of the listener or a 9.1-channel system in which six speakers are arranged at positions in a range from the side to the rear side of the listener has also been proposed in recent years, it is necessary to assure a space where a larger number of speakers can be arranged in such a case.

In the acoustic reproducing system using the multichannel, in order to obtain a better reproducing environment, it is necessary to pay attention to the positions where the speakers are arranged. For example, in the 5.1-channel system, it is recommended that L/R speakers are arranged at the positions whose open angles to the left and right from a C speaker in the front are equal to 30° and SL and SR speakers are arranged at the positions whose open angles to the left and right are equal to 110°±10° so that those speakers exist on an arc around the listener as a center. For example, according to a listening style in which the SL and SR speakers are arranged every audio listening time, it is difficult to always arrange the SL and SR speakers at the recommended positions.

Therefore, there has been proposed a virtual surround system for allowing the listener to feel such a three-dimensional stereophonic acoustic effect (hereinafter, referred to as a 3-dimensional acoustic effect) that the sounds are generated by using two channels of the L/R speakers in front of the listener as if they were generated from the directions where the speakers around the listener do not exist. The virtual surround system is realized by, for example, a method whereby head position transfer functions of transferring the sounds from the L/R speakers to both ears of the listener and head position transfer functions of transferring the sounds from an arbitrary position to the both ears of the listener are obtained and matrix arithmetic operations using the head position transfer functions are executed to signals which are outputted from the L and R speakers. In the virtual surround system, a sound image can be localized to a predetermined position around the listener by using only the L and R speakers arranged at the front left and front right positions of the listener.

The invention regarding a sound field signal reproducing apparatus for executing an acoustic reproduction with the-ambience without limiting the listening-position of the listener has been disclosed in JP-A-1994 (Heisei 6)-178395.

The invention regarding an acoustic reproducing system and an audio signal processing apparatus for allowing the listener to be conscious of a state as if a sound image does not exist at positions where the speakers are actually arranged but the sound image existed at positions different from those positions have been disclosed in JP-A-1998 (Heisei 10)-224900.

### SUMMARY OF THE INVENTION

In the virtual surround system as mentioned above, the 3-dimensional acoustic reproduction can be realized by two channels of the L and R speakers. In this instance, it is recommended that the L and R speakers are arranged at the positions whose open angles to the left and right when seen from the listener are equal to values in a range of about tens to 60°.

However, in the 2-channel reproduction, even if the L/R speakers are arranged at the recommended positions, the optimum listening range (hereinafter, also properly referred to as a sweet spot) for the listener becomes a narrow range. Such a tendency is enhanced as the open angles of the L/R speakers are larger. There is, consequently, such a problem that, in the case where the listening position is deviated or there are a plurality of listeners, the listening position is deviated from the sweet spot and the sufficient 3-dimensional acoustic effect cannot be obtained. There is also such a problem that, if the listening position is deviated from the sweet spot, a localization feeling of the sound image which is inherently-sensed by the listener is deviated and the listener is liable to feel a sense of discomfort.

It is, therefore, desirable to provide a virtual sound localization processing apparatus, a virtual sound localization processing method, and a recording medium in which, even if a listening position is deviated, there are a plurality of listeners, or the like, the listener can obtain a 3-dimensional acoustic effect.

According to an embodiment of the present invention, there is provided a virtual sound localization processing apparatus which forms first and second main signals for localizing a sound image to a predetermined position around a listening position from acoustic signals of a sound source, comprising:

first and second output terminals for outputting acoustic signals to be supplied-to first and second audio sound output units arranged at left and right positions, respectively;

third and fourth output terminals for outputting acoustic signals to be supplied to third and fourth audio sound output units arranged at positions near the first and second audio sound output-units, respectively; and

at least two or more auxiliary signal forming units for forming auxiliary signals for localizing the sound image to the predetermined position around the listening position from the acoustic signals of the sound source,

wherein the acoustic signal including at least the first main signal is supplied to the first output terminal, the acoustic signal including at least the auxiliary signals formed by the auxiliary signal forming units is supplied to the third output terminal, the acoustic signal including at least the second main signal is supplied to the second output terminal, and the acoustic signal including at least the auxiliary signals formed by the auxiliary signal forming units is supplied to the fourth output terminal.

According to an embodiment of the present invention, there is provided a virtual sound localization processing method comprising:

a main signal forming step of forming first and second main signals for localizing a sound image to a predetermined position around a listening position from acoustic signals of a sound source;

a first auxiliary signal forming step of forming first and second auxiliary signals for localizing the sound image to the predetermined position around the listening position from the acoustic signals of the sound source;

a second auxiliary signal forming step of forming third and fourth auxiliary signals for localizing the sound image to the predetermined position around the listening position from the acoustic signals of the sound source; and

a supplying step of supplying an acoustic signal obtained by synthesizing the first main signal and the first auxiliary signal to a first output terminal for outputting an acoustic signal to be supplied to a first audio sound output unit, supplying the second auxiliary signal to a third output terminal for outputting an acoustic signal to be supplied to a third audio sound output unit near the first audio sound output unit, supplying an acoustic signal obtained by synthesizing the second main signal and the third auxiliary signal to a second output terminal for outputting an acoustic signal to be supplied to a second audio sound output unit, and supplying the fourth auxiliary signal to a fourth output terminal for outputting an acoustic signal to be supplied to a fourth audio sound output unit near the second audio sound output unit.

According to an embodiment of the present invention, there is provided a recording medium which stores a program for allowing a computer to execute virtual sound localization processes comprising:

a main signal forming step of forming first and second main signals for localizing a sound image to a predetermined position around a listening position from acoustic signals of a sound source;

a first auxiliary signal forming step of forming first and second auxiliary signals for localizing the sound image to the predetermined position around the listening position from the acoustic signals of the sound source;

a second auxiliary signal forming step of forming third and fourth auxiliary signals for localizing the sound image to the predetermined position around the listening position from the acoustic signals of the sound source; and

a supplying step of supplying an acoustic signal obtained by synthesizing the first main signal and the first auxiliary signal to a first output terminal for outputting an acoustic signal to be supplied to a first audio sound output unit, supplying the second auxiliary signal to a third output terminal for outputting an acoustic signal to be supplied to a third audio sound output unit near the first audio sound-output unit, supplying an acoustic signal obtained by synthesizing the second main signal and the third auxiliary signal to a second output terminal for outputting an acoustic signal to be supplied to a second audio sound output unit, and supplying the fourth auxiliary signal to a fourth output terminal for outputting an acoustic signal to be supplied to a fourth audio sound output unit near the second audio sound output unit.

According to an embodiment of the present invention, particularly, the sweet spot in the virtual surround system which is realized by the speakers arranged in the front right and front left positions of the listener can be widened. Therefore, even if the listening position is deviated, there are a plurality of listeners, or the like, the listener can obtain the 3-dimensional acoustic effect.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing an example of a virtual sound localization processing apparatus in the first embodiment of the invention;

FIG. 2 is a block diagram showing a construction of a main signal processing unit in the first embodiment of the invention;

FIG. 3 is a schematic diagram which is referred to in order to obtain acoustic transfer functions;

FIG. 4 is a block diagram showing an example of a construction of a filter processing unit in the first embodiment of the invention;

FIG. 5 is a block diagram showing an example of a construction of an auxiliary signal forming unit in the first embodiment of the invention;

FIG. 6 is a schematic diagram showing an example at the time of use of the virtual sound localization processing apparatus in the first embodiment of the invention;

FIG. 7 is a block diagram showing an example of a virtual sound localization processing apparatus in the second embodiment of the invention;

FIG. 8 is a block diagram showing an example of an auxiliary signal forming unit in the second embodiment of the invention; and

FIG. 9 is a schematic diagram showing an example at the time of use of the virtual sound localization processing apparatus in the second embodiment of the invention.

### DETAILED DESCRIPTION OF THE PREFERRED EMBODIMENTS

The first embodiment of the invention will be described hereinbelow with reference to the drawings. In the specification, a process for mainly allowing the listener to be conscious of a sound image at a position where a sound source such as a speaker or the like does not actually exist is called a virtual sound localization process. In the specification, acoustic signals which are formed from acoustic signals of the sound source and are used to localize the sound image to a predetermined position around the listening position are called main signals and acoustic signals which are formed from specific acoustic signals (for example, acoustic signals for SL/SR speakers) of the sound source and are used to localize the sound image to a predetermined position around the listening position are called auxiliary signals.

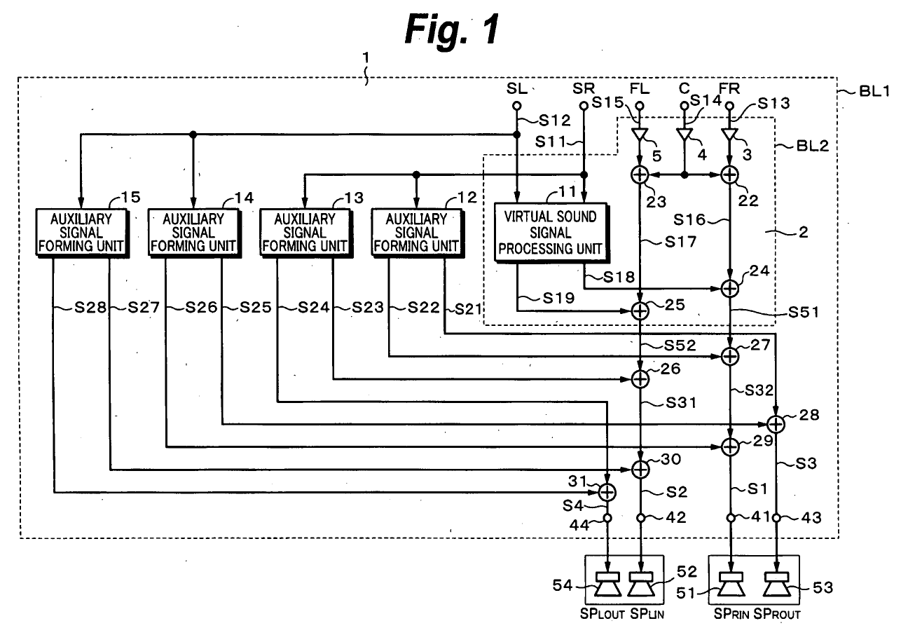

In FIG. 1, a portion surrounded by a broken line BL1 shows an example of a construction of a-virtual sound localization processing apparatus 1 in the first embodiment of the invention. An outline of the construction of the virtual sound localization processing apparatus 1 will now be described. The virtual sound localization processing apparatus 1 includes: a main signal processing unit 2 surrounded by a broken line BL2; auxiliary signal forming units 12 to 15 for forming auxiliary signals; and adders 26 to 31.

The virtual sound localization processing apparatus 1 also includes: an output terminal 41 as a first output terminal to which an acoustic signal S1 is supplied; an output terminal 42 as a second output terminal to which an acoustic signal S2 is supplied; an output terminal 43 as a third output terminal to which an acoustic signal S3 is supplied; and an output terminal 44 as a fourth output terminal to which an acoustic signal S4 is supplied.

The acoustic signal which is outputted from each output terminal is supplied to an audio sound output unit such as a speaker or the like. For example, the acoustic signal which is outputted from the output terminal 41 is supplied to a speaker 51 as a first audio sound output unit. The acoustic signal which is outputted from the output terminal 42 is supplied to-a speaker 52 as a second audio sound output unit. The acoustic signal which is outputted from the output terminal 43 is supplied to a speaker 53 as a third audio sound output unit. The acoustic signal which is outputted from the output terminal 44 is supplied to a speaker 54 as a fourth audio sound output unit.

In the first embodiment, the speakers 51 and 52 are arranged in the front left and front right positions of the listener. The speakers 51 and 53 are arranged at the close positions. The speakers 52 and 54 are also arranged at the close positions. The close positions denote positions which are away from each other by, for example, about 10 cm on the horizontal axis. At this time, for example, the speakers 51 and 53 may be enclosed in the same box and integrated-or may be independent speakers.

An outline of an acoustic reproducing system using the virtual sound localization processing apparatus 1 will now be described. For example, the acoustic signals of 5.1 channels are inputted to the virtual sound localization processing apparatus 1 from a acoustic signal source such as a DVD reproducing apparatus or the like (not shown). That is, the acoustic signal for the front right channel is inputted to an input terminal FR. The acoustic signal for the center channel is inputted to an input terminal C. The acoustic signal for the front left channel is inputted to an input terminal FL. The acoustic signal for the rear right channel is inputted to an input terminal SR. The acoustic signal for the rear left channel is inputted to an input terminal SL. The acoustic signal for the channel only for a low frequency band is inputted to an input terminal SW (not shown). In the following description, explanation about the acoustic signal for the channel only for low frequency band is omitted. For simplicity of explanation, description about signal processes of a video signal system is omitted.

In the virtual sound localization processing apparatus 1, by executing the signal processes, which will be explained hereinbelow, to the acoustic signals which are inputted to the respective input terminals, the foregoing acoustic signals S1 to S4 are formed and supplied to the output terminals 41 to 44, respectively.

The acoustic signals which are outputted from the output terminals are supplied to the speakers 51 to 54 connected to the output terminals and the sounds are generated from the speakers, respectively. The output terminal and the audio sound output unit, for example, the output terminal 41 and the speaker 51 may be connected by a wire or the acoustic signal which is outputted from the output terminal 41 may be analog- or digital-modulated and transmitted to the speaker 51.

The virtual sound localization processing apparatus 1 in the first embodiment of the invention will now be described in detail. First, an example of the main signal processing unit 2 in the virtual sound localization processing apparatus 1 will be described. An acoustic signal including an acoustic signal S18 as a first main signal and an acoustic signal including an acoustic signal S19 as a second main signal are formed by the main signal processing unit 2.

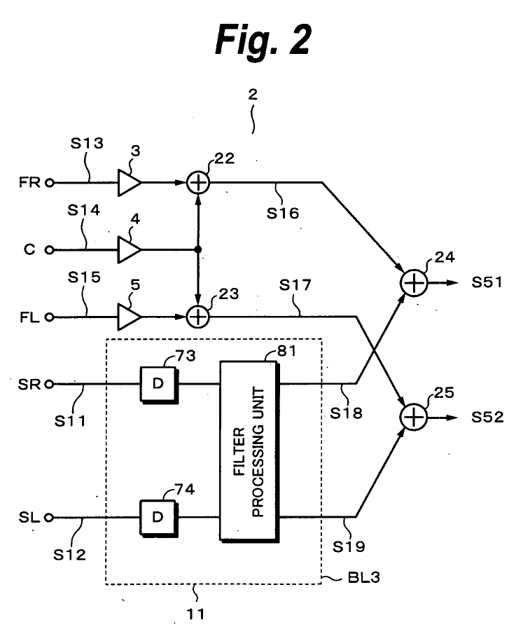

FIG. 2 shows an example of a construction of a main signal processing unit 2 in the first embodiment of the invention. As shown in FIG. 2, to the main signal processing unit 2, an acoustic signal S13 is supplied from the input terminal FR, an acoustic signal S14 is supplied from the input terminal C, an acoustic signal S15 is supplied from the input terminal FL, an acoustic signal S11 is supplied from the input terminal SR, and an acoustic signal S12 is supplied from the input terminal SL, respectively.

The acoustic signal, S13 is supplied to an adder 22 through an amplifier 3. The acoustic signal S14 is transmitted through an amplifier 4 and, thereafter, divided. One of the divided acoustic signal is supplied to the adder 22 and the other is supplied to an adder 23. The acoustic signal S15 is supplied to the adder 23 through an amplifier 5.

In the adder 22, an acoustic signal S16 is formed by synthesizing the acoustic signals S13 and S14. The formed acoustic signal S16 is supplied to an adder 24. In the adder 23, an acoustic signal S17 is formed by synthesizing the acoustic signals S14 and S15 the formed acoustic signal S17 is supplied to an adder 25.

The acoustic signals S11 and S12 are supplied to a virtual sound signal processing unit 11 surrounded by a broken line BL3. The acoustic signal S11 is delayed by a predetermined time by a delay unit 73 and supplied to a filter processing unit 81. Similarly, the acoustic signal S12 is delayed by a predetermined time by a delay unit 74 and supplied to the filter processing unit 81. The predetermined time to be delayed at this time is set to, for example, about a few milliseconds. The operation of the delay by each of the delay units 73 and 74 will be described hereinafter.

The acoustic signals S18 and S19 are formed by filtering processes in the filter processing unit 81. The acoustic signal S18 is supplied to the adder 24. The acoustic signal S19 is supplied to the adder 25.

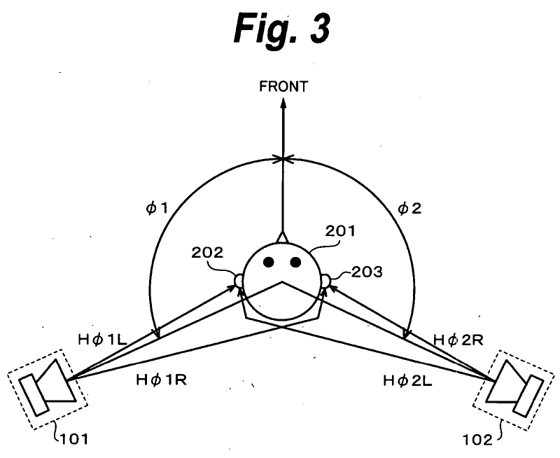

An example of the process in the filter processing unit 81 will now be described. For the process in the filter processing unit 81, as shown in FIG. 3, an acoustic transfer function Hφ1L to a left ear 202 of a listener 201 in the case where the audio sound is generated from a virtual speaker position 101 as an open angle φ1 from a front side of a listening space and an acoustic transfer function Hφ1R to a right ear 203 of the listener 201 are necessary. Similarly, an acoustic transfer function Hφ2L to the left ear 202 of the listener 201 in the case where the audio sound is generated from a virtual speaker position 102 as an open angle φ2 and an acoustic transfer function Hφ2R to the right ear 203 of the listener 201 are necessary.

The acoustic transfer functions as mentioned above can be obtained, for example, by the following method. The speakers are actually arranged at the virtual speaker positions 101 and 102 shown in FIG. 3 and a test signal such as an impulse sound or the like is generated from each of the arranged speakers. The acoustic transfer functions can be obtained by measuring impulse responses to the test signals at the positions of the right and left ears of a dummy head arranged at the position of the listener 201. That is, the impulse response measured at the position of the ear of the listener corresponds to the acoustic transfer function to the position of the ear of the listener from the position of the speaker which generated the test signal. On the basis of the acoustic transfer functions obtained in this manner, the processes are executed in the filter processing unit 81.

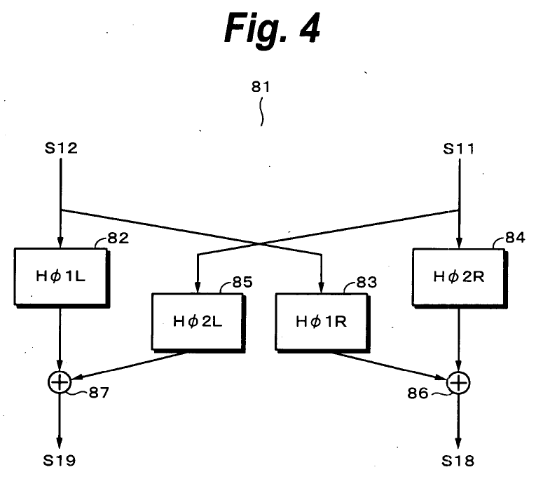

FIG. 4 shows an example of a construction of the filter processing unit 81 in the virtual sound signal processing unit 11. The filter processing unit 81 has filters 82, 83, 84, and 85 which are used for what is called a binauralizing process and adders 86 and 87.

The filters 82 to 85 are constructed by, for example, FIR (Finite Impulse Response) filters. As shown in FIG. 4, filter coefficients based on the foregoing acoustic transfer functions Hφ1L, Hφ1R, Hφ2R, and Hφ2L are used as filter coefficients of the filters 82 to 85.

The acoustic signal S11 delayed by the predetermined time by the delay unit 73 is supplied to the filters 84 and 85. The acoustic signal S12 is supplied to the filters 82 and 83.

In the filters 84 and 85, the acoustic signal S11 is converted on the basis of the acoustic transfer functions Hφ2R and Hφ2L. In the filters 82 and 83, the acoustic signal S12 is converted on the basis of the acoustic transfer functions Hφ1L and Hφ1R.

The acoustic signals outputted from the filters 83 and 84 are synthesized by the adder 86 and the acoustic signal S18 is formed. The acoustic signals outputted from the filters 82 and 85 are synthesized by the adder 87 and the acoustic signal S19 is formed. A process to cancel crosstalks which are caused upon reproduction from the speakers is further executed to the formed acoustic signals S18 and S19. Since the virtual sound signal process including the cross talk cancelling process and the foregoing binauralizing process has been disclosed in, for example, JP-A-1998-224900, its explanation is omitted here.

Assuming that the sound corresponding to the acoustic signal S18 formed as mentioned above has been generated from, for example, the right front speaker of the listener, he can listen to and sense the sound as if the sound image was localized at the speaker 102 in FIG. 3, that is, in the right rear position of the listener. Similarly, assuming that the sound corresponding to the acoustic signal S19 has been generated from, for example, the left front speaker of the listener, he can listen to and sense the sound as if the sound image was localized at the speaker 101 in FIG. 3, that is, in the left rear position of the listener.

The acoustic signal S18 outputted from the filter processing unit 81 is synthesized with the acoustic signal S16 by the adder 24. An acoustic signal S51 is formed by the synthesizing process in the adder 24. The formed acoustic signal S51 is outputted from the adder 24. The acoustic signal S19 outputted from the filter processing unit 81 is synthesized with the acoustic signal S17 by the adder 25. An acoustic signal S52, is formed by the synthesizing process in the adder 25. The formed acoustic signal S52 is outputted from the adder 25.

Explanation will be made by returning to FIG. 1. The virtual sound localization processing apparatus 1 in the first embodiment of the invention further includes the auxiliary signal forming units 12 to 15 for forming the auxiliary signals.

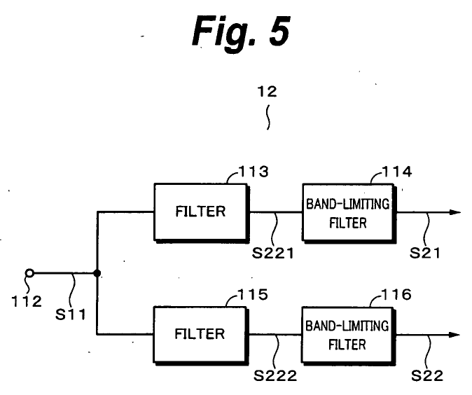

FIG. 5 shows an example of a construction of the auxiliary signal forming unit 12 as a first auxiliary signal forming unit. The acoustic signal S11 which is supplied from the input terminal SR is inputted to an input terminal 112 of the auxiliary signal forming unit 12. The inputted acoustic signal S11 is divided and the divided signals are supplied to filters 113 and 115. Each of the filters 113 and 115 is constructed by, for example, an FIR filter.

The acoustic transfer function which can be obtained by measuring the impulse response of the right ear of the dummy head arranged at the position of the listener to the test signal such as an impulse sound or the like generated from the right rear position of the listener, that is, from the position near the virtual speaker position 102 shown in FIG. 3 is used for a filter coefficient in the filter 113.

The acoustic transfer function which can be obtained by measuring the impulse response of the left ear of the dummy head arranged at the position of the listener to the test signal such as an impulse sound or the like generated from the right rear position of the listener, that is, from the position near the virtual speaker position 102 shown in FIG. 3 is used for a filter coefficient in the filter 115.

An acoustic signal S221 is formed by the filtering process in the filter 113. The acoustic signal S221 is supplied to a band-limiting filter 114 and subjected to a band-limiting process. That is, the acoustic signal S221 is limited to a predetermined band of, for example, 3 kHz (kilohertz) or lower.

The acoustic signal processed by the band-limiting filter 114 is outputted as an acoustic signal S21 as a first auxiliary signal from the auxiliary signal forming unit 12.

An acoustic signal S222 is formed by the filtering process in the filter 115. The acoustic signal S222 is limited to a predetermined band, for example, a band of 3 kHz or lower by a band-limiting filter 116. The acoustic signal processed by the band-limiting filter 116 is outputted as an acoustic signal S22 as a second auxiliary signal from the auxiliary signal forming unit 12.

The process to cancel the crosstalks which are caused upon reproduction from the speakers is further executed to the acoustic signals S21 and S22 which are outputted from the band-limiting filters 114 and 116. Since the virtual sound signal process including the crosstalk cancelling process and the foregoing binauralizing process has been disclosed in, for example, JP-A-1998-224900, its explanation is omitted here. The explanation regarding the crosstalk cancelling process and the like is also-omitted in the description of other auxiliary signal forming units.

The acoustic signal S21 is supplied to the adder 28. The acoustic signal S22 is supplied to the adder 27. In the adder 27, the acoustic signals S51 and S22 are synthesized and an acoustic signal S32 is formed. The formed acoustic signal S32 is outputted from the adder 27.

The auxiliary signal forming unit 13 as a second auxiliary signal forming unit is constructed in a manner similar to, for example, the auxiliary signal forming unit 12 and similar processes are executed. That is, the acoustic signal S11 is supplied to an input terminal (not shown) of the auxiliary signal forming unit 13. The acoustic signal S11 is divided and the filtering process and the band-limiting process are executed to each of the divided acoustic signals. An acoustic signal S23 as a third auxiliary signal and an acoustic signal S24 as a fourth auxiliary signal are formed by the filtering process, band-limiting process, and crosstalk cancelling process. The acoustic signals S23 and S24 are outputted from the auxiliary signal forming unit 13.

The acoustic signal S23 is supplied to the adder 26. The acoustic signal S24 is supplied to the adder 31. Since the acoustic signals S52 and S23 are synthesized in the adder 26, an acoustic signal S31 is formed. The formed acoustic signal S31 is supplied to the adder 30.

The auxiliary signal forming unit 14 as a third auxiliary signal forming unit in the first embodiment of the invention will now be described. The auxiliary signal forming unit 14 is constructed in a manner similar to, for example, the auxiliary signal forming unit 12 and similar processes are executed. That is, the auxiliary signal forming unit 14 includes filters and band-limiting filters.

The acoustic signal S12 is supplied to an input terminal of the auxiliary signal forming unit 14. The acoustic signal S12 is divided and the filtering process and the band-limiting process are executed to each of the divided acoustic signals. An acoustic signal S25 as a fifth auxiliary signal and an acoustic signal S26 as a sixth auxiliary signal are formed by the filtering process, band-limiting process, and crosstalk cancelling process. The formed acoustic signals S25 and S26 are outputted from the auxiliary signal forming unit 14.

As a filter coefficient of one of the two filters (not shown) in the auxiliary signal forming unit 14, there is used the acoustic transfer function which can be obtained by measuring the impulse response of the right ear of the dummy head arranged at the position of the listener to the test signal such as an impulse sound or the like generated from the left rear position of the listener, for example, from the position near the virtual speaker position 101 shown in FIG. 3.

As a filter coefficient of the other filter (not shown) in the auxiliary signal forming unit 14, there is used the acoustic transfer function which can be obtained by measuring the impulse response of the left ear of the dummy head arranged at the position of the listener to the test signal such as an impulse sound or the like generated from the left rear position of the listener, for example, from the position near the virtual speaker position 101 shown in FIG. 3.

In the band-limiting process in the auxiliary signal forming unit 14, a process for limiting each of the acoustic signals supplied to the band-limiting filters into a predetermined band, for example, a band which is equal to or lower than 3 kHz is executed.

The acoustic signal S25 which is outputted from the auxiliary signal forming unit 14 is supplied to the adder 28. Since the acoustic signals S21 and S25 are synthesized in the adder 28, the acoustic signal S3 is formed. The formed acoustic signal S3 is outputted from the adder 28 and supplied to the output terminal 43.

The acoustic signal S26 which is outputted from the auxiliary signal forming unit 14 is supplied to the adder 29. The acoustic signals S26 and S32 are synthesized in the adder 29 and the acoustic signal S1 is formed. The formed acoustic signal S1 is supplied to the output terminal 41.

Since a construction of the auxiliary signal forming unit 15 as a fourth auxiliary signal forming unit in the first embodiment of the invention and processes which are executed are similar to those of the auxiliary signal forming unit 14, their overlapped explanation is omitted here. The acoustic signals formed in the auxiliary signal forming unit 15 are outputted as an acoustic signal S27 as a seventh auxiliary signal and an acoustic signal S28 as a eighth auxiliary signal.

The acoustic signal S27 is supplied to the adder 30. In the adder 30, the acoustic signals S31 and S27 are synthesized and the acoustic signal S2 is formed. The formed acoustic signal S2 is supplied to the output terminal 42.

The acoustic signal S28 is supplied to the adder 31. In the adder 31, the acoustic signals S24 and S28 are synthesized and the acoustic signal S4 is formed. The formed acoustic signal S4 is supplied to the output terminal 44.

In this manner, the acoustic signals S1 to S4 are supplied to the output terminals 41 to 44. Sounds are generated from the speakers 51 to 54 connected to those output terminals, respectively.

The foregoing virtual sound localization processing apparatus 1 can be modified, for example, as follows. The acoustic signals S16 and S18 may be supplied to the different output terminals. Similarly, the acoustic signals S17 and S19 may be also supplied to the different output terminals. For example, the acoustic signal S16 may be supplied to the output terminal 41 and the acoustic signal S18 may be supplied to the output terminal 43. The acoustic signal S17 may be also supplied to the output terminal 42 and the acoustic signal S19 maybe also supplied to the output terminal 44.

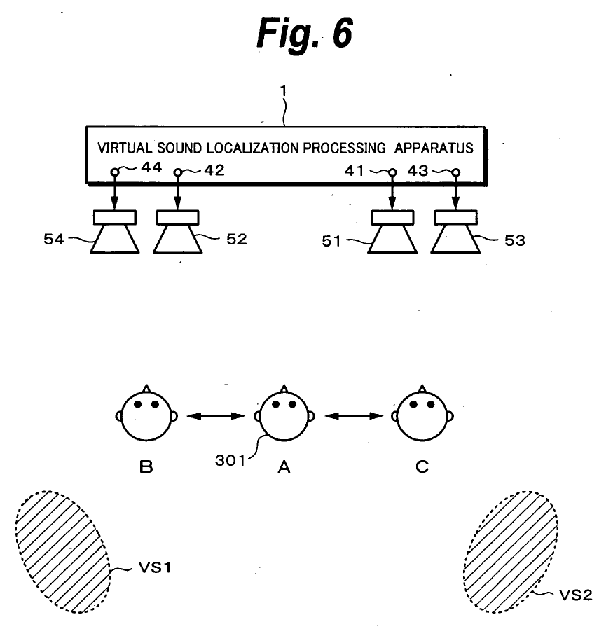

The operation in the case of using the virtual sound localization processing apparatus 1 will now be described with reference to FIG. 6. The acoustic signal S18 as a first main signal is included in the acoustic signal S1 which is generated as a sound from the speaker 51. Likewise, the acoustic signal S19 as a second main signal is included in the acoustic signal S2 which is generated as a sound from the speaker 52. The delaying processes have been executed to the acoustic signals S18 and S19 by the delay units 73 and 74 in the main signal processing unit 2, respectively. Therefore, the auxiliary signals S22 and S26 included in the acoustic signal S1 are precedently generated as sounds from the speaker 51 and the auxiliary signals S23 and S27 included in the acoustic signal S2 are precedently generated as sounds from the speaker 52, respectively.

The acoustic signal S3 including a plurality of auxiliary signals is generated as a sound from the speaker 53 and the acoustic signal S4 including a plurality of auxiliary signals is generated as a sound from the speaker 54, respectively.

The acoustic signal S1 including the delayed acoustic signal S18 and the acoustic signal S2 including the delayed acoustic signal S19 are generated as sounds with predetermined delayed times.

First, when a listener 301 is located at a center position A, the acoustic signals including a plurality of auxiliary signals are generated as sounds from the speakers 51 to 54, so that the listener 301 feels as if the sound images were localized at a left rear position VS1 and a right rear position VS2.

The acoustic signals S1 and S2 including the acoustic signals S18 and S19 are generated as sounds from the speakers 51 and 52 with the predetermined delayed times. Since the acoustic signals S1 and S2 including the acoustic signals S18 and S19 are generated as sounds, the sound images are localized at positions almost similar to the left rear position VS1 and the right rear position VS2.

Subsequently, the case where the listener 301 was moved to a left position B will be described. In the past, since the listener 301 is moved to the position B, he is out of the sweet spot, a localization feeling of the sound image which is sensed by the listener 301 is largely deviated and there is a case where the listener 301 feels a sense of discomfort.

However, according to the present invention, a change in the localization feeling of the sound image which is sensed by the listener 301 can be reduced. That is, the localization feeling of the sound image which is sensed by the listener 301 is a feeling for the sound image which is formed by the precedent sound effect. Further, such a sound image is constructed by a plurality of auxiliary signals and each of those auxiliary signals has been limited to the predetermined band, for example, the band of 3 kHz or lower in each of the auxiliary signal forming units.

Generally, as for the deviation of the localization feeling of the sound image which is sensed by the listener since he has moved, there is a tendency that a robustness of the acoustic signal in a low frequency band is higher than that of the acoustic signal in a high frequency band. Therefore, since the sound image is formed by a plurality of auxiliary signals in the low frequency band owing to the precedent sound effect, even if the position of the listener 301 is changed to the left position B or a right position C from the center position A, the change in the localization feeling of the sound image which is sensed by the listener can be reduced.

Further, in the virtual sound localization processing apparatus 1 in the first embodiment of the invention, the auxiliary signals which are generated as sounds from the speakers 51 to 54 contribute to the localization of the sound images in the right rear and left rear positions. Therefore, even if the listening position of the listener 301 is deviated, the stable sound image localization feeling can be obtained. In other words, the sweet spot can be widened more than that in the related art and the stereophonic acoustic effect can be obtained even in the case where the listening position of the listener is deviated or there are a plurality of listeners.

The second embodiment of a virtual sound localization processing apparatus of the invention will now be described. In the following explanation, the portions having constructions similar to those in the virtual sound localization processing apparatus 1 in the first embodiment mentioned above are designated by the same reference numerals.

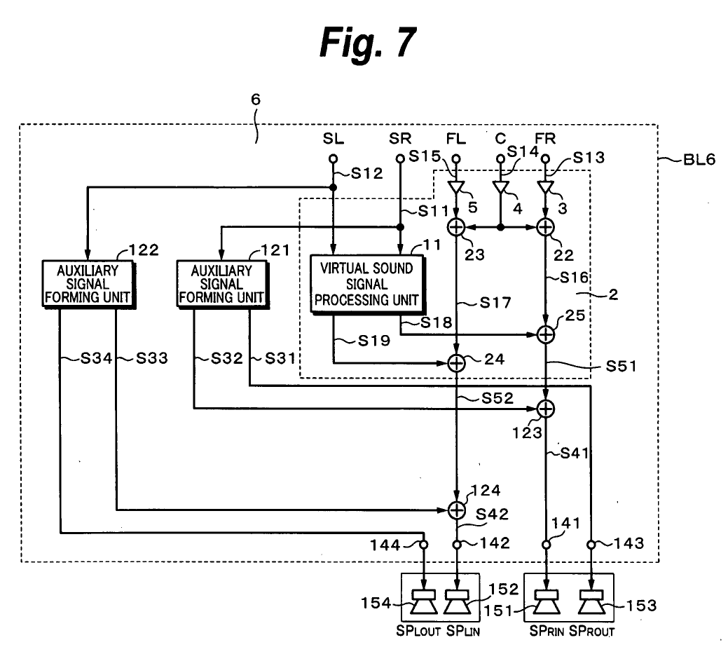

FIG. 7 shows an example of a construction of a virtual sound localization processing apparatus 6 in the second embodiment of the invention. The virtual sound localization processing apparatus 6 surrounded by a broken line BL6 includes: the main signal processing unit 2; auxiliary signal forming units 121 and 122; and adders 123 and 124.

The virtual-sound localization processing apparatus 6 also includes a first output terminal 141, a second output terminal 142, a third output terminal 143, and a fourth output terminal 144 to which acoustic signals are supplied, respectively. The output terminal 141 is connected to a speaker 151 as a first audio sound output unit. The output terminal 142 is connected to a speaker 152 as a second audio sound output unit. The output terminal 143 is connected to a speaker 153 as a third audio sound output unit. The output terminal 144 is connected to a speaker 154 as a fourth audio sound output unit. A connecting method is not limited and either a wired method or a wireless method may be used.

The speakers 151 and 152 are arranged in the front left and front right positions of the listener. The speakers 151 and 153 are arranged at the close positions. The speakers 152 and 154 are also arranged at the close positions. The close positions denote positions which are away from each other by, for example, about 10 cm on the horizontal axis. At this time, for example, the speakers 151 and 153 may be enclosed in the same box and integrated or may be independent speakers.

Unlike the virtual sound localization processing apparatus 1 described in the first embodiment, the virtual sound localization processing apparatus 6 has the two auxiliary signal forming units. Therefore, a scale of a circuit construction can be miniaturized. Since a construction of the main signal processing unit 2 and processes which are executed in the main signal processing unit 2 in the virtual sound localization processing apparatus 6 are similar to those in the main signal processing unit 2 described in the first embodiment, their overlapped explanation is omitted here. Since acoustic signals which are inputted to input terminals of the virtual sound localization processing apparatus 6 are also similar to those in the first embodiment, they will be explained in a manner similar to those mentioned in the first embodiment.

The inputted acoustic signals S11 to S15 are subjected to predetermined signal processes, adding processes, and the like in the main signal processing unit 2, so that the acoustic signal S51 including the acoustic signal S18 as a first main signal and the acoustic signal S52 including the acoustic signal S19 as a second main signal are formed. The acoustic signal S51 is supplied to the adder 123. The acoustic signal S52 is supplied to the adder 124. The acoustic signal S11 inputted to the input terminal SR is supplied to the auxiliary signal forming unit 121 as a first auxiliary signal forming unit.

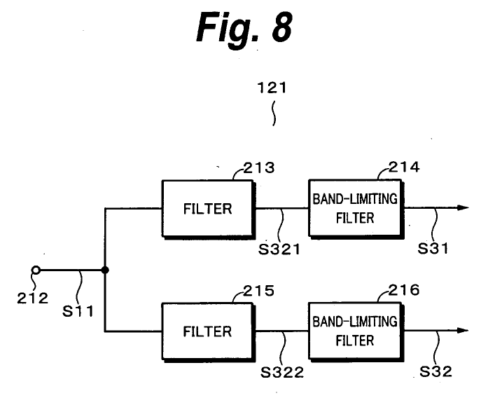

FIG. 8 shows an example of a construction of the auxiliary signal forming unit 121 in the second embodiment of the invention. The acoustic signal S11 supplied to an input terminal 212 of the auxiliary signal forming unit 121 is divided. The divided signals are supplied to filters 213 and 215 and a filtering process is executed to each of the divided acoustic signals.

The acoustic transfer function which can be obtained by measuring the impulse response of the right ear of the dummy head arranged at the position of the listener to the test signal such as an impulse sound or the like generated from the right rear position of the listener is used for a filter coefficient in the filter 213.

The acoustic transfer function which can be obtained by measuring the impulse response of the left ear of the dummy head arranged at the position of the listener to the test sound such as an impulse sound or the like generated from, for example, the right rear position of the listener is used for a filter coefficient in the filter 215.

An acoustic signal S321 as an output of the filter 213 is supplied to a band-limiting filter 214. The acoustic signal S321 is limited to a predetermined band, for example, a band of 3 kHz or lower. The acoustic signal S31 as a first auxiliary signal is formed by the band-limiting filter 214.

An acoustic signal S322 as an output of the filter 215 is supplied to a band-limiting filter 216. The acoustic signal S322 is limited to a predetermined band, for example, a band of 3 kHz or lower. The acoustic signal S32 as a second auxiliary signal is formed by the band-limiting filter 216.

The process to cancel the crosstalks which are caused upon reproduction from the speakers is further executed to the formed acoustic signals S31 and S32. Since the virtual sound signal process including the crosstalk cancelling process and the binauralizing process has been disclosed in, for example, JP-A-1998-224900 or the like, its explanation is omitted here. The explanation regarding the crosstalk cancelling process and the like to acoustic signals S33 and S34 which are outputted from the auxiliary signal forming unit 122 is also similarly omitted.

The formed acoustic signals S31 and S32 are outputted from the auxiliary signal forming unit 121. The acoustic signal S31 is supplied to the output terminal 143. The acoustic signal S32 is supplied to the adder 123. In the adder 123, the acoustic signals S51 and S32 are synthesized and an acoustic signal S41 is formed. The formed acoustic signal S41 is supplied to the output terminal 141.

The auxiliary signal forming unit 122 as a second auxiliary signal forming unit will now be described. Since a construction of the auxiliary signal forming unit 122 and processes which are executed there are similar to those of the auxiliary signal forming unit 121, their overlapped explanation is omitted here. The acoustic transfer functions which can be obtained by measuring the impulse responses of the right and left ears of the dummy head arranged at the position of the listener to the test sound such as an impulse sound or the like generated from, for example, the left rear position of the listener are used for filter coefficients in the filters in the auxiliary signal forming unit 122.

The acoustic signal S33 as a third auxiliary signal and the acoustic signal S34 as a fourth auxiliary signal are formed by the process in the auxiliary signal forming unit 122. The acoustic signal S33 outputted from the auxiliary signal forming unit 122 is supplied to the adder 124. In the adder 124, the acoustic signals S52 and S33 are synthesized and an acoustic signal S42 is formed. The formed acoustic signal S42 is supplied to the output terminal 142.

The acoustic signal S34 outputted from the auxiliary signal forming unit 122 is supplied to the output terminal 144.

As mentioned above, the predetermined acoustic signals are supplied to the output terminals 141 to 144 and the sounds are generated from the speakers 151 to 154 connected to the corresponding output terminals, respectively.

The foregoing virtual sound localization processing apparatus 6 can be modified, for example, as follows. The acoustic signals S16 and S18 may be supplied to the different output terminals. Similarly, the acoustic signals S17 and S19 may be also supplied to the different output terminals. For example, the acoustic signal S16 may be supplied to the output terminal 141 and the acoustic signal S18 may be supplied to the output terminal 143. The acoustic signal S17 may be also supplied to the output terminal 142 and the acoustic signal S19 may be also supplied to the output terminal 144.

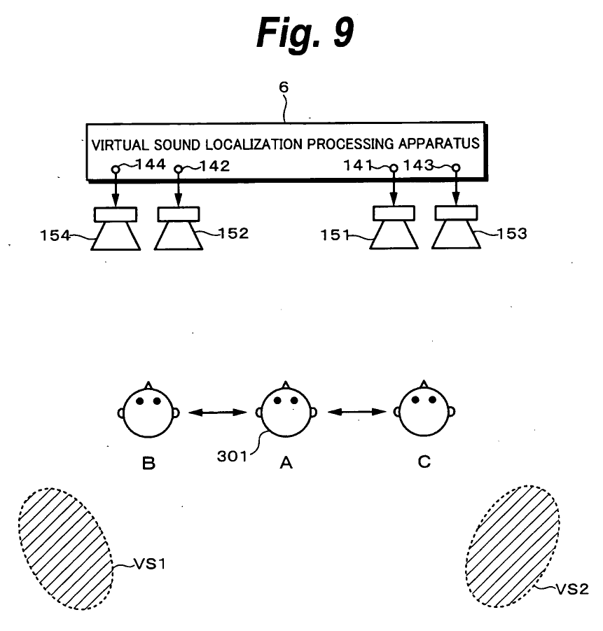

FIG. 9 is a diagram for explaining the main operation in the case of using the virtual sound localization processing apparatus 6. The main operation of the virtual sound localization processing apparatus 6 is substantially the same as that of the virtual sound localization processing apparatus 1. That is, since the acoustic signals including a plurality of auxiliary signals are generated as sounds from the speakers 151 to 154, the sound images VS1 and VS2 are localized. Since the band of each auxiliary signal has been limited to the low frequency side as mentioned above, even if the listener 301 is moved to the position shown at B or C, the deviation of the localization feeling of the sound image which is sensed by the listener is reduced, so that the listener can obtain the stereophonic acoustic effect.

However, for example, the signals to localize the sound image to the right rear position of the listener are not included in the acoustic signal which is supplied to the speaker 154. Therefore, for example, the deviation of the localization feeling of the sound image in the right rear position when the listener 301 is moved from the position A to the position B can be larger than that in the virtual sound localization processing apparatus 1 described in the first embodiment. However, the virtual sound localization processing apparatus 6 described in the second embodiment has an advantage that the sweet spot can be widened by the simple circuit construction.

Many modifications and applications of the present invention are possible within the scope without departing from the spirit of the invention and the invention is not limited to the foregoing embodiments. For example, the speakers may be arranged so that the directions of the reproduction sounds which are generated from the speakers 51 and 53 which are close to each other are set to be parallel or set to directions other than the parallel direction. The filter coefficients of the filters in each of the auxiliary signal forming units may be also set in consideration of the directivity of the speakers and the position of the listener.

Although the first and second embodiments have been described above on the assumption that the acoustic signals of the sound source are the signals of 5.1 channels, naturally, the invention may be also applied to acoustic signals of a sound source of another system. A plurality of auxiliary signal forming units may be provided in accordance with the acoustic signals of the sound source.

Although the functions of the virtual sound localization processing apparatuses have been described by using the constructions in the specification, they may be also realized as methods. Further, the processes which are executed in the respective blocks of the virtual sound localization processing apparatuses described in the specification may be also realized as, for example, computer software such as programs or the like. In this case, the processes in the respective blocks function as steps constructing a series of processes.

By supplying the acoustic signals processed by the virtual sound localization processing apparatuses of the invention to the speakers and generating the sounds from the speakers, an acoustic signal reproducing system may be realized.

It should be understood by those skilled in the art that various modifications, combinations, sub-combinations and alterations may occur depending on design requirements and other factors insofar as they are within the scope of the appended claims or the equivalents thereof.

What is claimed is:

1. A virtual sound localization processing apparatus which forms first and second main signals for localizing a sound image to a predetermined position around a listening position from acoustic signals of a sound source, comprising:
first and second output terminals outputting acoustic signals to be supplied to first and second audio sound output units arranged at left and right positions, respectively;
third and fourth output terminals outputting acoustic signals to be supplied to third and fourth audio sound output units arranged at positions near said first and second audio sound output units, respectively; and
at least two or more auxiliary signal forming units forming auxiliary signals for localizing the sound image to the predetermined position around the listening position from the acoustic signals of the sound source,
wherein the acoustic signal including at least the first main signal is supplied to said first output terminal, the acoustic signal including at least the auxiliary signals formed by said auxiliary signal forming units is supplied to said third output terminal, the acoustic signal including at least the second main signal is supplied to said second output terminal, and the acoustic signal including at least the auxiliary signals formed by said auxiliary signal forming units is supplied to said fourth output terminal.

2. An apparatus according to claim 1, further comprising a filter unit limiting each of the auxiliary signals formed by said auxiliary signal forming units to a predetermined frequency band.

3. An apparatus according to claim 1, further comprising a delay processing unit executing a delaying process to each of said first and second main signals.

4. An apparatus according to claim 1, wherein said auxiliary signal forming units have:
a first auxiliary signal forming unit forming first and second auxiliary signals for localizing the sound image to the predetermined position around the listening position from said acoustic signals; and
a second auxiliary signal forming unit forming third and fourth auxiliary signals for localizing the sound image to the predetermined position around the listening position from said acoustic signals,
and an acoustic signal obtained by synthesizing the first main signal and the first auxiliary signal is supplied to said first output terminal,
the second auxiliary signal is supplied to said third output terminal,
an acoustic signal obtained by synthesizing the second main signal and the third auxiliary signal is supplied to said second output terminal, and
the fourth auxiliary signal is supplied to said fourth output terminal.

5. An apparatus according to claim 1, wherein said auxiliary signal forming units have:
a first auxiliary signal forming unit forming first and second auxiliary signals for localizing the sound image to the predetermined position around the listening position from said acoustic signals;
a second auxiliary signal forming unit forming third and fourth auxiliary signals for localizing the sound image to the predetermined position around the listening position from said acoustic signals;
a third auxiliary signal forming unit forming fifth and sixth auxiliary signals for localizing the sound image to the predetermined position around the listening position from said acoustic signals; and
a fourth auxiliary signal forming unit forming seventh and eighth auxiliary signals for localizing the sound image to the predetermined position around the listening position from said acoustic signals,
and an acoustic signal obtained by synthesizing the first main signal, the second auxiliary signal, and the sixth auxiliary signal is supplied to said first output terminal,
an acoustic signal obtained by synthesizing the first auxiliary signal and the fifth auxiliary signal is supplied to said third output terminal,
an acoustic signal obtained by synthesizing the second main signal, the third auxiliary signal, and the seventh auxiliary signal is supplied to said second output terminal, and
an acoustic signal obtained by synthesizing the fourth auxiliary signal and the eighth auxiliary signal is supplied to said fourth output terminal.

6. An apparatus according to claim 1, wherein said auxiliary signal forming units have:
a first auxiliary signal forming unit forming first and second auxiliary signals for localizing the sound image to the predetermined position around the listening position from said acoustic signals;
a second auxiliary signal forming unit forming third and fourth auxiliary signals for localizing the sound image to the predetermined position around the listening position from said acoustic signals;
a third auxiliary signal forming unit forming fifth and sixth auxiliary signals for localizing the sound image to the predetermined position around the listening position from said acoustic signals; and
a fourth auxiliary signal forming unit forming seventh and eighth auxiliary signals for localizing the sound image to the predetermined position around the listening position from said acoustic signals,
and an acoustic signal obtained by synthesizing the first main signal, the first auxiliary signal, and the fifth auxiliary signal is supplied to said first output terminal,
an acoustic signal obtained by synthesizing the second auxiliary signal and the sixth auxiliary signal is supplied to said third output terminal,
an acoustic signal obtained by synthesizing the second main signal, the fourth auxiliary signal, and the eighth auxiliary signal is supplied to said second output terminal, and
an acoustic signal obtained by synthesizing the third auxiliary signal and the seventh auxiliary signal is supplied to said fourth output terminal.

7. A virtual sound localization processing method comprising:
a main signal forming step of forming first and second main signals for localizing a sound image to a predetermined position around a listening position from acoustic signals of a sound source;
a first auxiliary signal forming step of forming first and second auxiliary signals for localizing the sound image to the predetermined position around the listening position from the acoustic signals of the sound source;
a second auxiliary signal forming step of forming third and fourth auxiliary signals for localizing the sound image to the predetermined position around the listening position from the acoustic signals of the sound source; and
a supplying step of supplying an acoustic signal obtained by synthesizing the first main signal and the first auxiliary signal to a first output terminal for outputting an acoustic signal to be supplied to a first audio sound output unit, supplying the second auxiliary signal to a third output terminal for outputting an acoustic signal to be supplied to a third audio sound output unit near said first audio sound output unit, supplying an acoustic signal obtained by synthesizing the second main signal and the third auxiliary signal to a second output terminal for outputting an acoustic signal to be supplied to a second audio sound output unit, and supplying the fourth auxiliary signal to a fourth output terminal for outputting an acoustic signal to be supplied to a fourth audio sound output unit near said second audio sound output unit.

8. A recording medium which stores a program for allowing a computer to execute virtual sound localization processes comprising:
a main signal forming step of forming first and second main signals for localizing a sound image to a predetermined position around a listening position from acoustic signals of a sound source;
a first auxiliary signal forming step of forming first and second auxiliary signals for localizing the sound image to the predetermined position around the listening position from the acoustic signals of the sound source;
a second auxiliary signal forming step of forming third and fourth auxiliary signals for localizing the sound image to the predetermined position around the listening position from the acoustic signals of the sound source; and
a supplying step of supplying an acoustic signal obtained by synthesizing the first main signal and the first auxiliary signal to a first output terminal for outputting an acoustic signal to be supplied to a first audio sound output unit, supplying the second auxiliary signal to a third output terminal for outputting an acoustic signal to be supplied to a third audio sound output unit near said first audio sound output unit, supplying an acoustic signal obtained by synthesizing the second main signal and the third auxiliary signal to a second output terminal for outputting an acoustic signal to be supplied to a second audio sound output unit, and supplying the fourth auxiliary signal to a fourth output terminal for outputting an acoustic signal to be supplied to a fourth audio sound output unit near said second audio sound output unit.
